(19) United States
(12) Patent Application Publication
(10) Pub. No.: US 2014/0033081 A1
(43) Pub. Date: Jan. 30, 2014

(54) CONTENT PERSONALIZATION SYSTEM

(71) Applicants: Antonio Fernandez, Pompano Beach, FL (US); Ronnie Paskin, Ft. Lauderdale, FL (US); Vinh Tran, Coral Springs, FL (US)

(72) Inventors: Antonio Fernandez, Pompano Beach, FL (US); Ronnie Paskin, Ft. Lauderdale, FL (US); Vinh Tran, Coral Springs, FL (US)

(73) Assignee: CBS INTERACTIVE INC., San Francisco, CA (US)

(21) Appl. No.: 13/560,720

(22) Filed: Jul. 27, 2012

(51) Int. Cl. G06F 3/048; G06F 15/16

(52) U.S. Cl. 715/760; 709/203; 715/764

(57) ABSTRACT

A sports content personalization system is described. A method may comprise receiving sports content at a server computing device, the sports content associated with content data related to subject matter of the sports content; generating a user profile comprising user data, the user data indicating one or more sports content interests; and presenting personalized sports content on a user interface comprising sports content selected based on the user data and the content data, the user interface presented on a display of a client computing device. Other embodiments are described and claimed.

### BACKGROUND

The proliferation of online distribution channels has made the dissemination of online content easier than ever. For instance, sports fans are no longer limited to receiving information about their favorite teams from traditional sources such as newspapers or television, for example, the local news or national broadcasters like the Entertainment and Sports Programming Network (ESPN®). There is now a wide variety of content producers producing sports-related content, such as news, team, and league websites, as well as non-traditional content providers, including trade rumor websites and fantasy games/sports websites. As such, users have efficient access to the greatest amount of sports information that has ever been available. However, the wealth of accessible content may actually be counterproductive, in that it may actually make finding subject matter of interest more difficult to achieve. Users may now be overwhelmed with information each time that they visit a website to get updates about their favorite team. For example, a user visiting the website for Major League Baseball (MLB®) or ESPN® to see how their team did in yesterday's game, may be inundated with scores, articles, and videos about every other team except their team of interest, especially if their team is not in a major television market.

Difficulty in efficiently locating meaningful information and content may dissuade users from seeking information from online sources, which will lead to decreased visits and content interaction at content provider websites. Therefore, one design goal for content providers is to develop content platforms capable of automatically and dynamically delivering personalized content to users. As such, techniques designed to personalize content presentation and offerings are desirable.

### BRIEF DESCRIPTION OF THE DRAWINGS

FIG. 1 illustrates an embodiment of a sports content personalization system.

FIG. 2 illustrates an embodiment of a first operating environment for a sports content personalization application.

FIG. 3 illustrates an embodiment of a second operating environment for a sports content personalization application.

FIG. 4 illustrates an embodiment of a third operating environment for a sports content personalization application.

FIGS. 5A-5B illustrate an embodiment of a fourth operating environment for a content personalization application.

FIG. 6 illustrates a logic flow in accordance with one or more embodiments.

FIG. 7 illustrates a second logic flow in accordance with one or more embodiments.

FIG. 8 illustrates a computing architecture in accordance with one or more embodiments.

FIG. 9 illustrates an embodiment of a communications architecture.

### DETAILED DESCRIPTION

In general, individual consumers of online content may have a particular list of preferences used when locating and consuming online content. In many cases, however, these preferences are intangible mental thoughts, or materialized in the form of a stored list of browser links to favorite websites. A user may do some online searches of various topics using any number of different search tools, or simply traverse a list of browser links to peruse various types of website content, such as news articles, show summaries, sports information, or any other topic of interest. However, this is a manual process that sometimes requires a user to search through large volumes of online content to find a particular content item of interest. The problem is further exacerbated as a volume of online content and content sources grows over time.

Various embodiments attempt to solve these and other problems. Embodiments are generally directed to techniques for presenting personalized media content on a user interface to users based on information associated with the users. In one embodiment, users may register with the user interface or an entity serving the user interface (e.g., a website served by a web server) and create a user profile. The embodiments may automatically and dynamically update user information based on certain events, including, without limitation, user interaction with content, user specified profile information, or external data sources. The user interface may comprise a website presenting online content. Users may be presented with online content based on associated profile information elements, including user specified elements and elements determined based on user interaction with the content. For instance, a profile information element may indicate that a user prefers content related to a particular topic or interest. According to embodiments, a user having profile information may visit a user interface and may be presented with personalized content according to associated profile information.

Some embodiments are particularly directed to techniques for presenting personalized content for a live or recorded event, such as a sports-related event, on a user interface to users based on information associated with the users. In one embodiment, users may register with the user interface or an entity serving the user interface (e.g., a website served by a web server) and create a user profile. The embodiments may automatically and dynamically update user information based on certain events, including, without limitation, user interaction with the sports content, user specified profile information, or external data sources. The user interface may comprise a website presenting sports content, such as videos, articles, box scores, statistics, leagues, standings, schedules, player and team information, and electronic commerce (“e-commerce”). Users may be presented with sports content based on associated profile information elements, including user specified elements and elements determined based on user interaction with the content. In one embodiment, profile information elements may include, without limitation, teams, players, content type (e.g., videos, fantasy statistics), leagues, conferences, and products. For instance, a profile information element may indicate that a user prefers content related to a particular team and other teams in the same conference. According to embodiments, a user having profile information may visit a user interface and may be presented with personalized sports content according to associated profile information.

By way of example, sports fans typically have one or more favorite teams for various sports, some of which are of more interest than others. For example, a fan may follow Team A for football and Team B for baseball, but may have a much higher interest for Team A over Team B. Certain fans are very passionate about an entire sport, such as the National Hockey League (NHL®), or just about their team within a league. For collegiate sports, it is common for a fan to be interested in an entire conference, such as the Pacific-12 (PAC 12) or the Atlantic Coast Conference (ACC). In addition, fans may be interested in certain types of content, for instance, preferring video content, articles, box scores, or statistics. In order to keep visitor interest and to encourage return website visits, content providers may benefit from a system that presents sports content tailored to each visitor's interests. In addition, content providers may leverage user interest in a particular content offering to attract users to other programs. A user may create a profile reflecting such preferences, and have associated content automatically delivered to a user ready for consumption in a standardized user interface. This reduces search times for meaningful content, as well as keeps a user in a single viewing context (e.g., rather than switching between browser windows). It is with respect to these and other considerations that the present improvements have been needed to increase content consumption, build product loyalty, increase online advertising revenue, and attract new content consumers.

In addition to live events, fans of fantasy games based on live events may also have a set of preferences useful for selectively consuming content related to certain fantasy games. Accordingly, some embodiments are directed to techniques for presenting personalized fantasy content on a user interface to users based on information associated with the users.

A fantasy game is one where participants act as an owner to build a team that competes against other fantasy owners based on statistics generated by real individual players of a game. Fantasy sport is a class of fantasy games. For instance, a fantasy owner might draft a fantasy football team to compete with other fantasy football teams based on statistics generated by real football players from the National Football League (NFL). A common variant uses a computer model to convert statistical performance into points that are compiled and totaled according to a roster selected by a manager of a fantasy team. As with a real team, a fantasy owner is given various online tools to sign, trade and cut fantasy players just like a real team owner.

In general, a game is a system in which players engage in an artificial conflict, defined by rules and a scoring system, resulting in a quantifiable outcome. A fantasy game is a game based on a quantifiable outcome of another game. More particularly, a fantasy game uses a scoring system that is based, at least in part, on a quantifiable outcome of another game in order to obtain a quantifiable outcome for the fantasy game. For instance, a fantasy sport game may comprise a fantasy team selected from human players of a real sport. The fantasy sport game may convert statistical information of human player performance in real sporting competitions (e.g., a football game, a baseball game, etc.) into points that are compiled and totaled according to a roster of a fantasy team. Fantasy players of the fantasy sport game then compete based on the totaled points.

Fantasy games may be based on any type or genre of games. Some examples of games may include without limitation sports, board games, video games, games of chance, lawn games, tabletop games, party games, dexterity games, coordination games, card games, dice games, domino and tile games, guessing games, video games, electronic games, electronic video games, online games, role-playing games, business games, simulation games, television games, reality television games, artificial reality games, and so forth. A fantasy game may be based on any of these or other types of games. A particularly large segment of fantasy games focus on sports, such as football, basketball, baseball, soccer, hockey, racing, and so forth. Recently, emerging fantasy game genres have branched out to include non-sports related games focused on politics, celebrity gossip, movies, and reality television. For instance, fantasy congress is a fantasy game where players, called citizens, could draft members of the United States House and Senate, and keep track of their participation within the U.S. Congress. Actions, especially within the process of making and amending pieces of legislation, of a player's drafted congresspersons are recorded and rated as a cumulative total amount of points against other players. The embodiments are not limited in this context.

Fantasy games may have many fantasy game genres. For example, fantasy sport is a class of fantasy games. A fantasy owner might draft a fantasy football team to compete with other fantasy football teams based on statistics generated by real football players from the National Football League (NFL). Fantasy reality TV is another class of fantasy games. For instance, a fantasy owner might draft a fantasy reality team to compete with other fantasy reality teams based on statistics generated by reality show contestants, such as contestants for such reality shows as Big Brother, Survivor, American Idol, Dancing With The Stars, The Apprentice, Fear Factor, The Amazing Race, and so forth. Fantasy board is another class of fantasy games. For instance, a fantasy owner might draft a fantasy board game team to compete with other fantasy board game teams based on statistics generated by board game contestants, such as chess players, poker players, checker players, monopoly players, or other board games. Fantasy electronic is another class of fantasy games. For instance, a fantasy owner might draft a fantasy electronic game team to compete with other fantasy electronic game teams based on statistics generated by electronic game contestants, such as electronic video game players, electronic gambling game players, and other electronic games. The embodiments are not limited in this context.

Some embodiments are directed to techniques for presenting personalized fantasy content on a user interface to users based on information associated with the users. In one embodiment, users may register with the user interface or an entity serving the user interface (e.g., a website served by a web server) and create a user profile. The embodiments may automatically and dynamically update user information based on certain fantasy events, including, without limitation, user interaction with the fantasy game content, user specified profile information, or external data sources. The user interface may comprise a website presenting fantasy content, such as videos, articles, box scores, statistics, leagues, standings, schedules, player and team information, third party applications, and electronic commerce (“e-commerce”). Users may be presented with fantasy content based on associated profile information elements, including user specified elements and elements determined based on user interaction with the content. In one embodiment, profile information elements may include, without limitation, teams, players, content type (e.g., videos, fantasy statistics), leagues, conferences, and products. For instance, a profile information element may indicate that a user prefers content related to a particular team and other teams in the same fantasy conference. According to embodiments, a user having profile information may visit a user interface and may be presented with personalized fantasy content according to associated profile information.

It may be appreciated that these are merely a few categories and examples of online content, and others exist as well. The embodiments are not limited to a particular type of line content.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

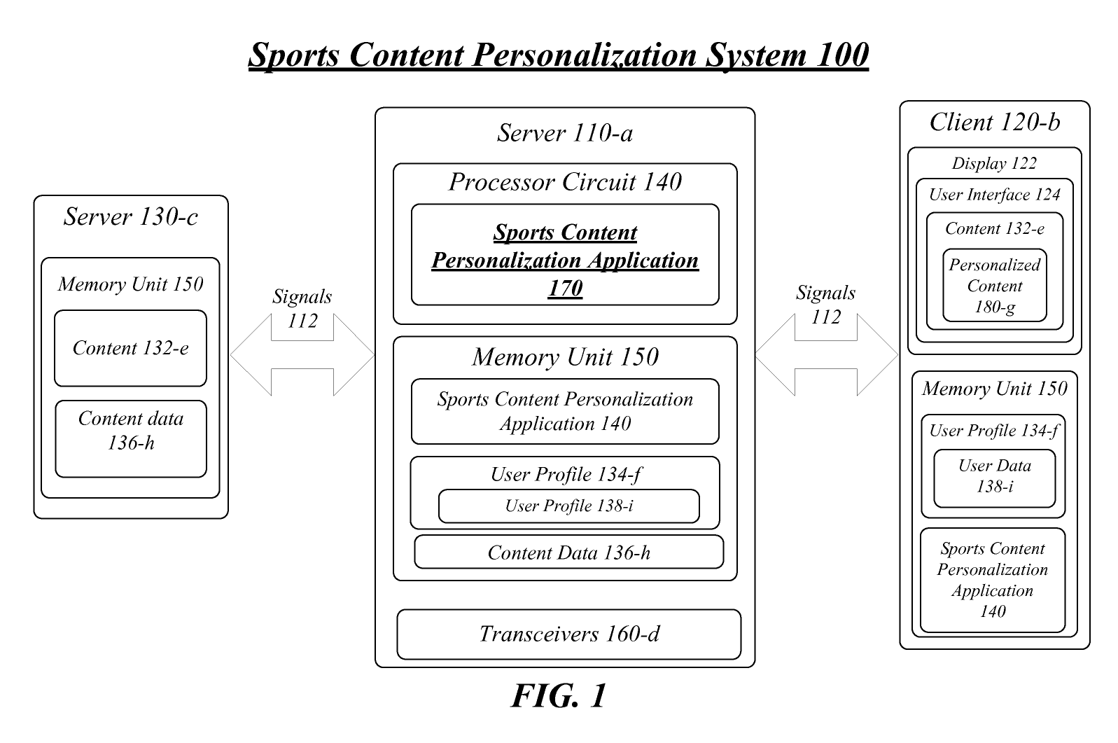

FIG. 1 illustrates a block diagram for a sports content personalization system 100. In one embodiment, the sports content personalization system 100 may comprise a computer-based system comprising a server 110-a. The server 110-a may comprise, for example, a processor circuit 140, a memory unit 150, and one or more transceivers 160-d. The server 110-a may further comprise a sports content personalization application 170. The memory unit 150 may store an unexecuted version of the sports content personalization application 170. Although the sports content personalization system 100 shown in FIG. 1 has a limited number of elements in a certain topology, it may be appreciated that the sports content personalization system 100 may include more or less elements in alternate topologies as desired for a given implementation.

It is worthy to note that “a,” “b,” “c” and similar designators as used herein are intended to be variables representing any positive integer. Thus, for example, if an implementation sets a value for a=5, then a complete set of servers 110-a may include servers 110-1, 110-2, 110-3, 110-4, and 110-5. The embodiments are not limited in this context.

In various embodiments, the sports content personalization system 100 may comprise multiple computing devices, such as servers 110-a, 130-c and clients 120-b. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, servers 110-a and 130-c may be implemented as a web server and a network server, respectively, accessible over a network, such as the Internet. The client 120-b may be implemented as a desktop computer or a mobile device having a portable power supply and wireless communications capabilities, such as a laptop computer, handheld computer, tablet computer, smart phone, gaming device, consumer electronic, or other mobile device. The embodiments are not limited to these examples, however, and any servers 110-a, 130-c and clients 120-b may be used as desired for a given implementation. The servers 110-a may communicate with other computing devices 130-c, 120-b using communications signals 112 via the transceivers 160-d. The embodiments are not limited in this context.

In various embodiments, the sports content personalization system 100 may comprise a processor circuit 140. The processor circuit 140 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 140.

In various embodiments, the sports content personalization system 100 may comprise a memory unit 150. The memory unit 150 may store, among other types of information, the sports content personalization application 170, content data 136-h, and user profiles 134-f. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Content 132-e may comprise any defined set of electronic information, data, or content capable of being uniquely identified, presented by a user interface 124, or represented by a user interface element of a user interface 124. One example of a user interface 124 may comprise a graphical user interface (GUI). According to certain embodiments, content 132-e may be associated with content data 136-h, for example, comprising data describing one or more features of the content 132-e. One exemplary class of content 132-e may include, without limitation, software computer files, including application files (e.g., document files, word processing files, spreadsheet files, presentation files, etc.), system files (e.g., operating system files, library files, utility files, etc.), and multimedia content files (e.g., audio files, video files, audio/video files, picture files, image files, etc.). Other examples of content 132-e may include without limitation objects presented by a user interface 124, user interface elements, GUI elements, multimedia content (e.g., pictures, images, video, audio, graphics, games, discussion forums, blogs, contests, etc.), software programs, views of software programs, application documents, application content (e.g., a paragraph from a word processing document or work sheet from a spreadsheet document), a web page, a web site, a uniform resource locator (URL) from a web browser, clipboard data, screenshots, device resource data (e.g., sensor data), and so forth. These are merely a few examples, and any type of defined set of electronic information, data, or content may comprise content 132-e as utilized in the sports content personalization system 100. As illustrated in FIG. 1, the content 132-e may be located on servers 110-a or on a computing device accessible by the servers 110-a, such as one or more of servers 130-c as depicted in FIG. 1, through the transceivers 160-d. The embodiments are not limited in this context.

Users may access content 132-e through a user interface 124 accessible by a display 122 of a client 120-b. The display 122 may comprise any digital display device suitable for the one or more clients 120-b. For instance, the display 122 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content 132-e on a user interface 124 to a user of the one or more clients 120-b.

In various embodiments, the servers 110-a may comprise one or more transceivers 160-d. Each of the transceivers 160-d may be implemented as wired transceivers, wireless transceivers, or a combination of both. In some embodiments, the transceivers 160-d may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 160-d may comprise or implement various communication techniques to allow the servers 110-a to communicate with other electronic devices, such as the servers 130-c and the clients 120-b. For instance, the wireless transceivers 160-d may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the servers 110-a may implement different types of transceivers 160-d. Each of the transceivers 160-d may implement or utilize a same or different set of communication parameters to communicate information between various electronic devices. In one embodiment, for example, each of the transceivers 160-d may implement or utilize a different set of communication parameters to communicate information between the servers 110-a and one or more remote devices, such as remote servers 130-c and remote clients 120-b. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 160-d. The embodiments are not limited in this context.

In one embodiment, for example, the transceiver 160-d may comprise a radio designed to communicate information over a wireless local area network (WLAN), a wireless metropolitan area network (WMAN), a wireless wide area network (WWAN), or a cellular radiotelephone system. The transceiver 160-d may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 160-d may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

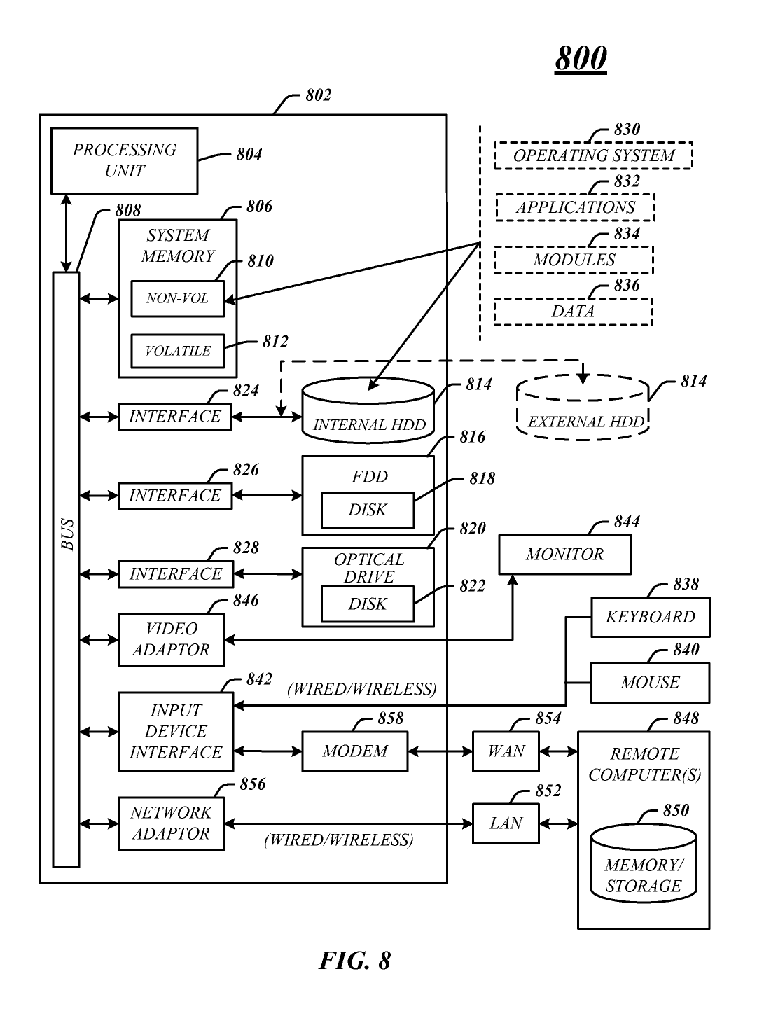

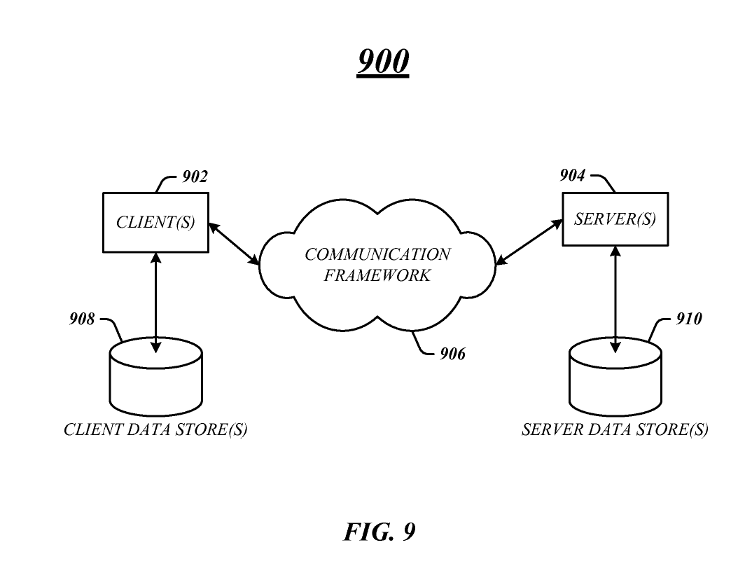

Although not shown, the servers 110-a, 130-c, and clients 120-b may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIGS. 8-9. The embodiments, however, are not limited to these examples.

In the illustrated embodiment shown in FIG. 1, the processor circuit 140 may be communicatively coupled to the transceiver 160-d and the memory unit 150. The memory unit 150 may store a sports content personalization application 170 arranged for execution by the processor circuit 140 to present content 132-e and personalized content 180-g to one or more clients 120-b through a user interface 124 via the transceivers 160-d. The servers 130-c and clients 120-b may implement similar elements as the servers 110-a, including a processor circuit 140, a memory unit 150, and transceivers 160-d. For example, servers 130-c may be comprised of a memory unit 150 storing content 132-e and content data 136-h associated with the content 132-e. The user profiles 134-f may be stored on servers 110-a, on clients 120-b, or some combination thereof. In one embodiment, the user profiles 134-f may be stored on the clients 120-b as cookies or similar variations thereof. The sports content personalization application 170 may access the user profiles 134-f of users accessing content 132-e at the user interface 124 through communication signals 112 received at the transceivers 160-d.

Servers 130-c may be comprised of a memory unit 150 storing content 132-e associated with content data 136-h. In one embodiment, the content data 136-h may provide information about the subject matter of the content 132-e, for example, to allow for the selection of personalized content 180-g from the corpus of content 132-e. For instance, the content data 136-h, may comprise, without limitation, game information, teams, players, statistics, league information, conference information, scores and scoring play information, dates, content authors and/or owners, content sources (e.g., news content provider, league content provider, such as NFL® Films), ratings (e.g., popularity ratings, relevancy ratings, impact ratings, etc.). In one embodiment, the server 130-c may comprise or be in communication with a third-party content provider configured to provide content 132-e, content data 136-h, or both to the sports content personalization system 100.

Certain embodiments provide that user profiles 134-f may comprise information associated with one or more sports content personalization system 100 users. For example, each sports content personalization system 100 user may register with the system and create a user profile 134-f. The user profile 134-f may comprise user data 138-i about the user including, but not limited to, name, demographic and location information, sports content preferences (e.g., favorite teams, sports, leagues, conferences, etc.), content form preferences (e.g., video, textual, audio/visual, live streaming video), and any other information relevant to personalizing content 132-e. In addition, the sports content personalization application 170 may operate to monitor user activity within the sports content personalization system 100. For example, user interaction (e.g., browsing patterns, content accesses, etc.) with content 132-e may be monitored and stored as user data 138-i within the user profile 134-f as user interaction data.

The sports content personalization application 170 may generally provide features to present personalized content 180-g on a user interface 124 based on content data 136-h associated with the content 132-e and user data 138-i associated with users accessing the content 132-e. In one embodiment, a client 120-b may access the sports content personalization application 170 operating on a server 110-a, and any content 132-e associated therewith, utilizing a web browser application executing on the client 120-b including without limitation Microsoft® Internet Explorer®, Mozilla® Firefox®, Apple® Safari®, and Google Chrome™ browser applications. In another embodiment, a client 120-b may access the sports content personalization application 170 operating on a server 110-a utilizing a thin-client application and any associated thin-client hardware accessible by the client 120-b, including, but not limited to, ultra-thin client, web thin client, and mobile thin client implementations. In a further embodiment, the client 120-b may execute its own version of the sports content personalization application 170, such as a mobile application (“app” or “mobile app”) version of the sports content personalization application 170 communicating with the server 110-a to receive content 132-e, personalized content 180-g, and transmitting user profile 134-f and user data 138-i.

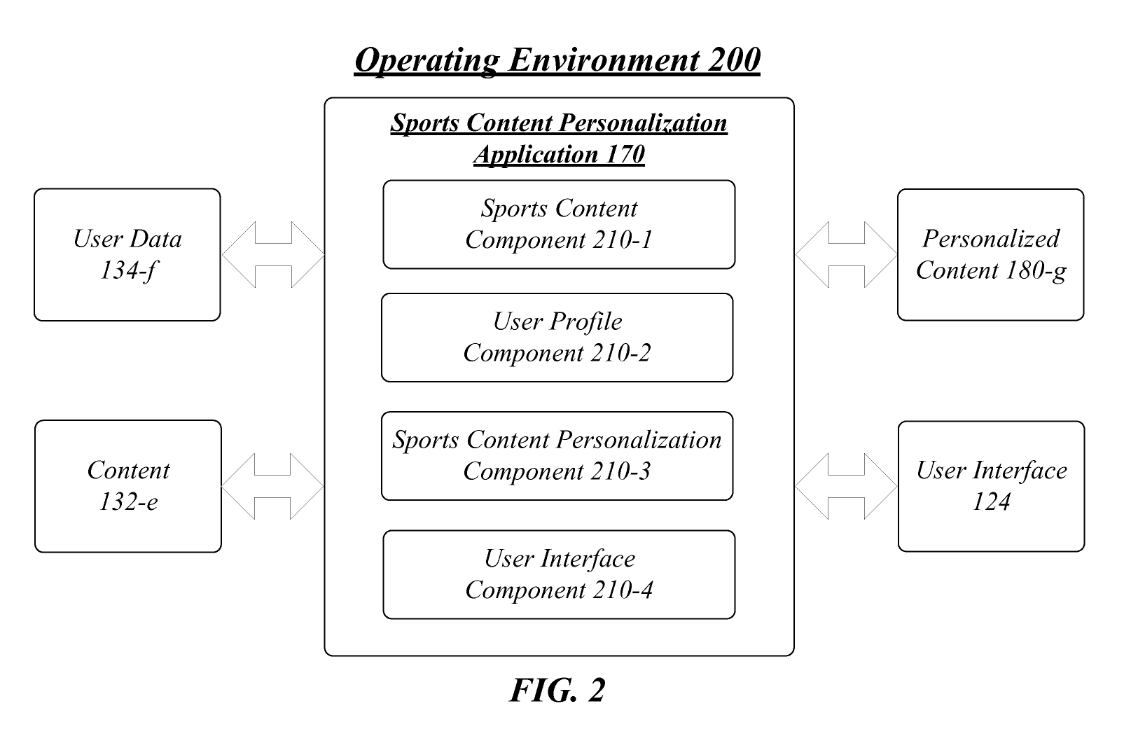

Particular aspects, embodiments and alternatives of the sports content personalization system 100 and the sports content personalization application 170 may be further described with reference to FIG. 2.

FIG. 2 illustrates an embodiment of an operating environment 200 for the sports content personalization system 100. More particularly, the operating environment 200 may illustrate a more detailed block diagram for the sports content personalization application 170.

As shown in FIG. 2, the sports content personalization application 170 may comprise various components 210-j. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the sports content personalization application 170 may comprise a sports content component 210-1, a user profile component 210-2, a sports content personalization component 210-3, and a user interface component 210-4. Although the sports content personalization application 170 shown in FIG. 2 has only four components in a certain topology, it may be appreciated that the sports content personalization application 170 may include more or less components in alternate topologies as desired for a given implementation. The embodiments are not limited in this context.

The sports content component 210-1 may generally operate to manage content 132-e for the sports content personalization system 100. Content 132-e may include original content and secondary content associated with or derived from the original content. For example, original content may comprise video content of a live broadcast of a sporting event. Secondary content may include, without limitation, files comprising video, audio, and audio/video derived from the original live sporting event broadcast, including video clips, audio segments, pictures and other graphical elements, and textual content related to the original content (e.g., an article written about the sporting event).

The sports content component 210-1 may provide access to content 132-e to the server 110-a and the sports content personalization application 170 operating thereon. The client 120-b may access the content 132-e from server 110-a, which may be configured as a web server. In one embodiment, the sports content component 210-1 may associate the content 132-e with content data 136-h. For example, the sports content component 210-1 may analyze the content to determine information about the subject matter of the content, such as in metadata associated with the content, or by processing images, sound, words, text, and graphics included in the content 132-e. In another embodiment, the sports content component 210-1 obtains content data 136-h from a third-party, such as the content provider. For instance, content 132-e received from MLB® content sources may be associated with content data 136-h provided by the MLB® content provider. Illustrative and non-restrictive examples of content data 136-h include game information, sport category (e.g., baseball, football, hockey) and level (e.g., professional, collegiate), teams, players, popularity rankings, quality ratings, descriptions, keywords, scores, scoring plays, game situations (e.g., content 132-e involving touchdowns, home runs, goals, etc.), sports entities (e.g., leagues, divisions, conferences), and any other information associated with the content 132-e that may be relevant to providing personalized content 180-g to users.

The user profile component 210-2 may generally operate to manage user profiles 134-f associated with sports content personalization system 100 users. For example, users may register with the sports content personalization system 100 and may create a user profile 134-f comprising user data 138-i. Non-limiting examples of user data 134-f include name, location and demographic information, accessed content 132-e, preferences, sports content personalization system 100 interaction information, keyword searches, and combinations thereof. Preference user data 134-f may include, without limitation, favorite teams, players, sports, leagues, conferences, divisions, content (e.g., home runs regardless of team, potential no-hitters regardless of team, top plays, game-winning scores regardless of team, etc.) The user profile component 210-2 may obtain and maintain user profiles 134-f and user data 138-i contained within the user profiles 134-f. In one embodiment, the user profiles 134-f and user data 138-i may be stored entirely or partially on the server 110-a. When a user logs into the server 110-a, for example, using login credentials associated with their user profile 134-f, the user profile component 210-2 may operate to access any user data 138-i for use by the sports content personalization application 170. In another embodiment, some or all of the user profile 134-f and/or user data 138-i may be wholly or partially stored on a client 120-b. In this embodiment, a user may log into the server 110-a and the user profile component 210-2 may obtain the user data 138-i from the client 120-b via communication signals 112.

The user data 138-i may be assigned weights indicating an interest level, preference level, or inferred interest level of sports content personalization system 100 users. In one embodiment, the user profile component 210-2 may assign one or more weights to user data 138-i elements, for example, as default values. According to embodiments, users may assign weights or preferences to user data 138-i elements within their user profile 134-f. For example, user data 138-i related to MLB® baseball may assign a larger weight, indicating a higher interest, on videos for home runs content 132-e. A user may assign a lower weight to videos for home runs, and increase the weight for videos for top fielding plays content 132-e. These serve as illustrative and non-restrictive examples. Embodiments are not so limited.

The sports content personalization component 210-3 may generally operate to select content 132-e as personalized content based on the content information 136-h and the user profile 134-f. The sports content personalization component 210-3 may obtain the user data 138-i for a user as contained within a user profile 134-f associated with the user from the user profile component 210-2. The sports content component 210-1 may operate to provide the sports content personalization component 210-3 with content data 136-h for available content 132-e. The sports content personalization component 210-3 may analyze the user data 138-i and the content data 136-h to determine content 132-e that may likely be of interest to the user associated with the user profile 134-f. For example, a user may be associated with user data 138-i indicating football as a preferred sport and Team A as a favorite football team. As such, the sports content personalization component 210-3 may search the content 132-e, using the information contained in the content data 136-h, to locate content 132-e pertaining to football Team A. Such content may be selected as personalized content 180-g as it is content that matches the user profile 134-f of a particular user.

The sports content personalization component 210-3 may additionally locate content 132-e that may be of interest to the user, but that is not a one-to-one match (e.g., Team A preference matching with Team A content). For example, content 132-e relating to a team in the same division as Team A may be selected as personalized content 180-g. However, all content 132-e may not have the same level of interest for a particular user. As such, all content 132-e related to Team A may be selected as personalized content 180-g; however, only significant content 132-e (e.g., trades, injuries, playoff implications) may be selected for other teams, such as teams in the same division as Team A. In another example, if Team A is competing with Team B from another division, for a wild card playoff spot near the end of the season, the sports content personalization component 210-3 may select content 132-e related to Team B as this is likely to be of high interest to fans of Team A.

In one embodiment, the significance of the content 132-e may be indicated by the content data 136-h, such as a rating system assigned by the sports content personalization system 100 or by the content provider (e.g., NFL®, MLB®). In this manner, content 132-e having a general interest to all fans (e.g., as indicated by a high user interest rating) of a sport or league may be selected as personalized content 180-g although the particular player or team is not set as a preferred element in the user profile 134-f. For example, for a user profile 134-f indicating an interest in a football league or a fantasy football league, content 132-e relating to a league-wide significant injury, trade, playoff implications, suspension, or record may be selected as personalized content by the content personalization component 210-3.

The user interface component 210-4 may generally operate to present personalized content 180-g, for example, via a user interface 124 provided on a display 122 coupled to a client 120-b. The user interface component 210-4 may present such content 132-e as personalized content 180-g, for instance, in a specified area of the user interface 124. The user interface component 210-4 may interact with the sports content personalization component 210-3 to receive personalized content 180-g for display on the user interface 124.

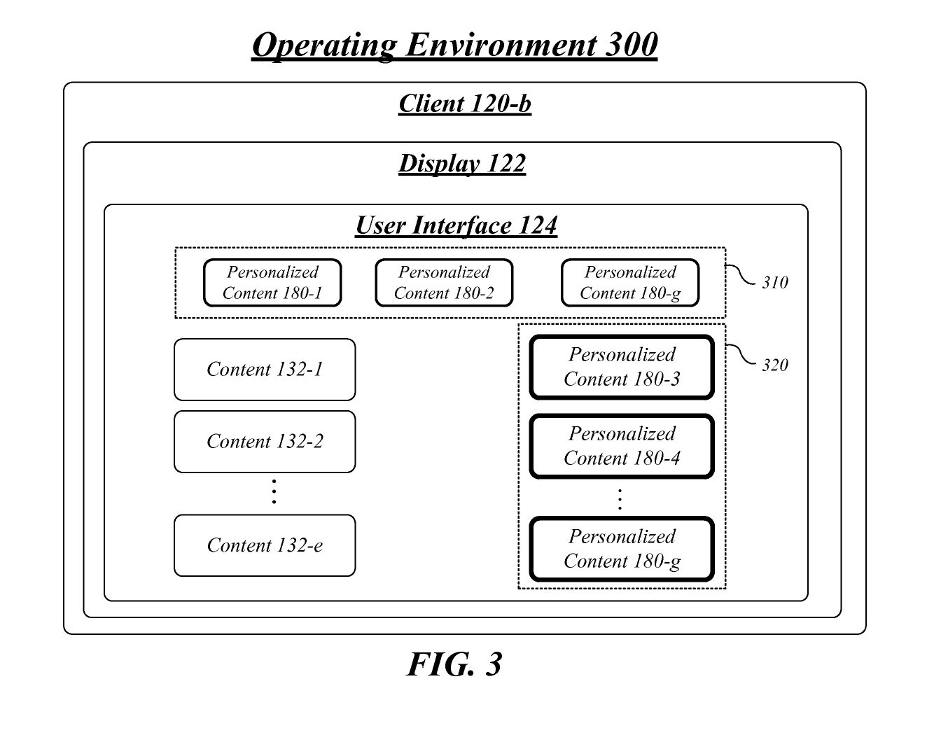

FIG. 3 illustrates an embodiment of an operating environment 300 for the sports content personalization system 100. More particularly, the operating environment 300 may illustrate a user interface 124 comprising personalized content 180-g provided according to embodiments described herein.

In the illustrated embodiment shown in FIG. 3, the user interface 124 may be presented to a user via a display 122 coupled to a client 120-b. For example, the user interface 124 may comprise an application interface for an application associated with a sports content provider, such as a mobile app configured for a mobile computing device. In another example, the user interface 124 may comprise a website for a sports content provider. Sports content 132-1, 132-2, 132-e may be presented on the user interface 124. For instance, the content 132-1, 132-2, 132-e may comprise various graphics, links, audio, video, games, contests, articles, blogs, and highlight compilations associated with sports content 132-e, such as a broadcast of a live game event. The user interface component 210-4 may present personalized content 180-g on the user interface in various forms. For example, a news feed 310 may be presented on the user interface 124 comprising personalized content 180-1, 180-2, 180-g scrolling across the user interface 124. In another example, the personalized may be associated with a personalized content window 310 for displaying personalized content 180-3, 180-4, 180-g for a particular user visiting the user interface 124. Embodiments are not limited to displaying personalized content 180-g in a segmented area of the use interface, such as a news feed 310 or personalized content window 320. For example, a separate web page or application window may be utilized for displaying personalized content 180-g.

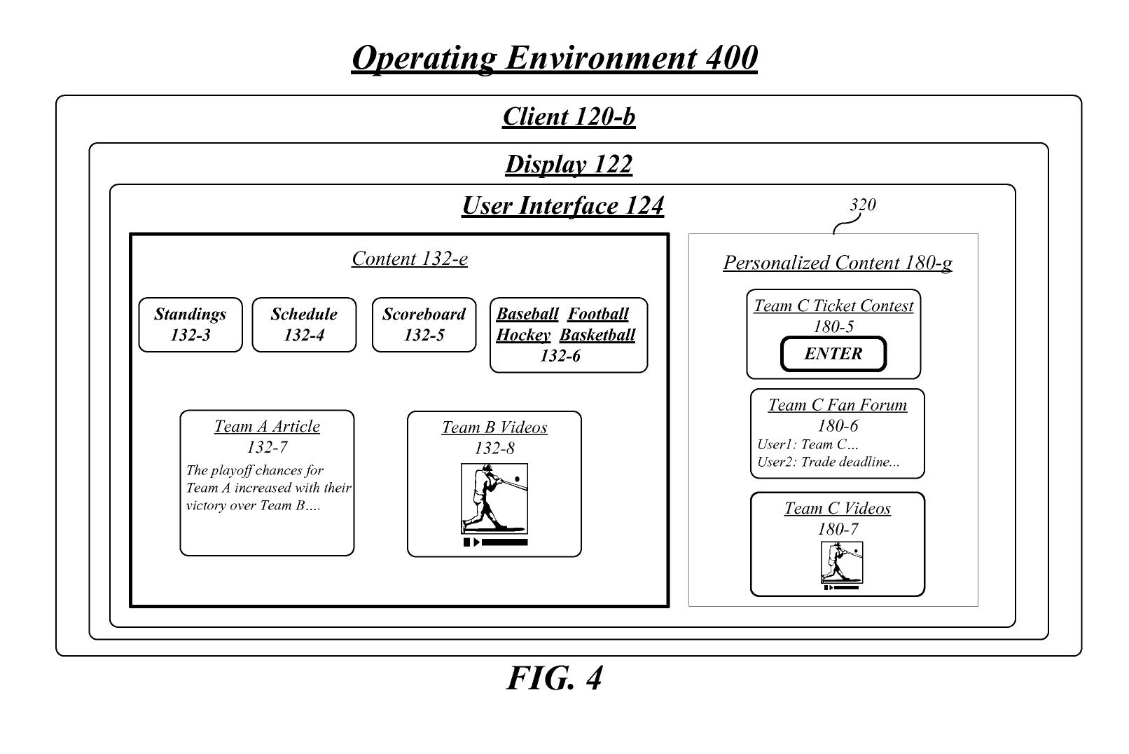

FIG. 4 illustrates an embodiment of an operating environment 400 for the sports content personalization system 100. More particularly, the operating environment 400 may illustrate a more detailed example of personalized content 180-g presentation on a user interface 124.

FIG. 4 illustrates a second case where the user interface component 210-4 presents personalized content 180-g on a user interface 124 provided through a display 122 coupled to a client 120-b. The user interface 124 may present various content 132-e elements, including, without limitation, standings 132-3, schedule 132-4, scoreboard 132-5, sport selection 132-6, an article pertaining to a specific team 132-7, and videos related to a specific team 132-8. In addition, the user interface component 210-4 may present a personalized content window 320 on the user interface for displaying personalized content 180-g. In the example embodiment of FIG. 4, the personalized content 180-g comprises a ticket contest 180-5, a fan forum 180-6, and videos 180-7 each relating to baseball Team C. According to embodiments, the user profile 134-f for a user viewing the user interface 124 as depicted in FIG. 4 may have user data 138-i indicating a preference for baseball and Team C. In addition, the user profile 134-f may indicate that the associated user is interested in contests 180-5, such as ticket contests, and participating in user discussion forums 180-6. In one embodiment, one or more of such interests (e.g., forums, contests, teams, sports, content type) may be entered by a user in an associated user profile 134-f. In another embodiment, the user profile component 210-2 may monitor user browsing patterns and update the user profile 134-f accordingly. For example, the browsing pattern for a particular user may indicate an interest in contests. As such, the user profile component 210-2 may increase the weight for a user data 138-i element related to user interests in contests for the user associated with the user profile 134-f.

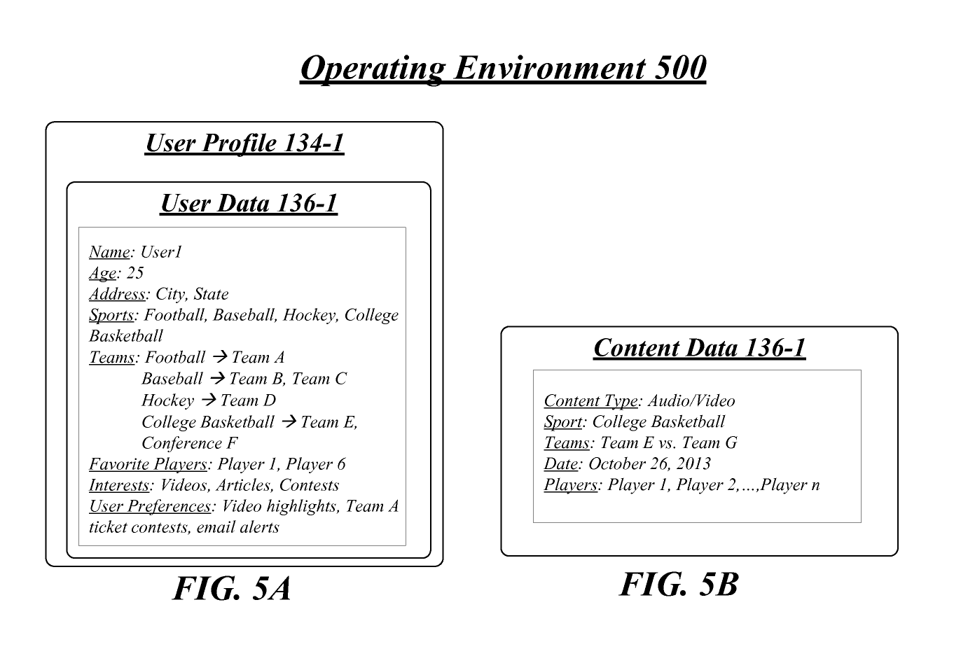

FIGS. 5A and 5B illustrate embodiments of an operating environment 500 for the sports content personalization system 100. More particularly, the operating environment 500 may illustrate a more detailed example of a user profile 134-1 and content data 136-1 according to embodiments described herein.

Referring to FIG. 5A, therein is provided a user profile 134-1 comprising user data 138-1 according to an embodiment. The user data 138-1 elements include name, age, address, sports, teams, favorite players, interests, and user preferences. The user data 138-1 elements are non-limiting and for illustrative purposes only. In FIG. 5B, therein is provided illustrative and non-restrictive examples of content data 136-1, including content type, sport, teams, date, and players. In an exemplary embodiment, the content personalization component may access the content data 136-1 and the user data 138-1 and select the content 132-e associated with the content data 136-1 as personalized content 180-g because, inter alia, Team E is listed as a team in the user data 138-1 and as a team in the content data 136-1.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

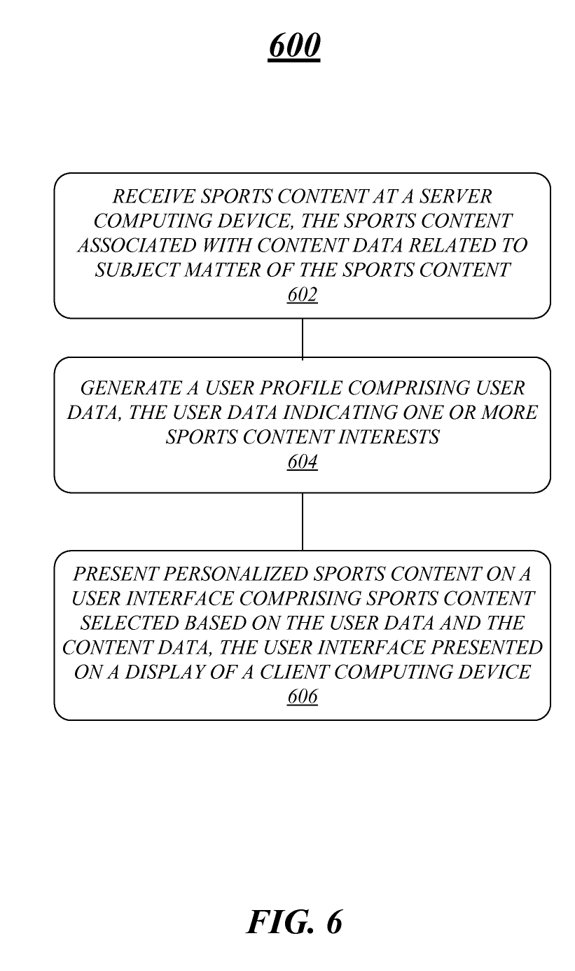

FIG. 6 illustrates one embodiment of a logic flow 600. The logic flow 600 may be representative of some or all of the operations executed by one or more embodiments described herein. For example, the logic flow 600 may illustrate operations performed by the sports content personalization system 100.

In the illustrated embodiment shown in FIG. 6, the logic flow 600 may receive sports content at a server computing device, the sports content associated with content data related to subject matter of the sports content at block 602. For example, the sports content personalization application 170 operating on server 110-a may access content 132-e stored on server 130-c, such as through the sports content component 210-1. The content 132-e may be comprised of sports content associated with one or more sports content providers, including, without limitation, substantially live game event broadcasts, streaming audio/video content, graphics, pictures, articles, and derivations thereof. According to embodiments, the content 132-e may be associated with content data 136-h configured to provide information about the content 132-e. Exemplary forms of content data 136-h include game information, teams, players, scores, scoring plays, game entities (e.g., leagues, divisions, conferences, etc.), content type, and dates.

The logic flow 600 may generate a user profile comprising user data, the user data indicating one or more sports content interests at block 604. For example, a user may register with the sports content personalization system 100, creating a user profile 134-f. The user profile 134-f may contain user data 138-i, such as demographic information and user interest information. The user profile component 210-2 may operate to manage the generation and retrieval of user profiles 134-f and user data 138-i contained therein.

The logic flow 600 may present personalized sports content on a user interface comprising sports content selected based on the user data and the content data, the user interface presented on a display of a client computing device at block 606. For example, the user interface component 210-4 may analyze the user data 134-f for a particular user and the content information 136-h to select content 132-e as personalized content 180-g for presentation on the user interface 124. The personalized content 180-g may be presented on a user interface 124 accessible from a display 122 of a client computing device 120-b.

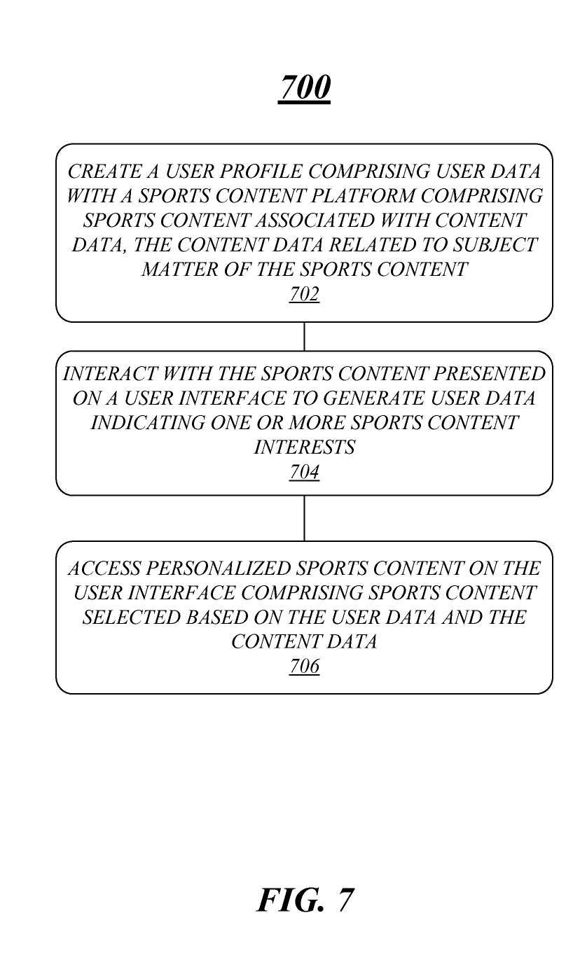

FIG. 7 illustrates one embodiment of a logic flow 700. The logic flow 700 may be representative of some or all of the operations executed by one or more embodiments described herein. For example, the logic flow 700 may illustrate operations performed by the sports content personalization system 100.

The logic flow 700 may create a user profile comprising user data with a sports content platform comprising sports content associated with content data, the content data related to subject matter of the sports content at block 702. For example, a user may register with the sports content personalization system 100 comprising content 132-e associated with content data 136-h. According to embodiments, the content data 136-h may be configured to provide information about the subject matter of the content 132-e, such as game information, and the teams and players involved in the game. Registered users may be associated with a user profile 134-f containing user data 138-i arranged to indicate user interest in the content 132-e, such as preferred sports, teams, or players.

The logic flow 700 may interact with the sports content presented on a user interface to generate user data indicating one or more sports content interests at block 704. For example, a registered user may login to the sports content personalization system 100 utilizing credentials provided in their user profile 134-f. The user may access content 132-e presented on the user interface 124, such as a website associated with a sports content provider. A registered user logged into the sports content personalization system 100 may be associated with user data 134-f related to accessed content 132-e. For instance, the user may access certain content 132-e (e.g., live streaming videos of a football game, highlight videos, or articles concerning a specific team) and exhibit certain browsing patterns. This information concerning accessed content and browsing patterns may be stored as user data 138-i in a user profile 134-f, for example, to indicate potential interest in content 132-e or content presentation.

The logic flow 700 may access personalized sports content on the user interface comprising sports content selected based on the user data and the content data at block 706. For example, the content personalization component 210-3 may select content 132-e as personalized content 180-g based on the content data 136-h and the user data 138-i. The user interface component 210-4 may present the personalized content 180-g on a user interface 124 accessible from a display 122 of a client computing device 120-b. A user may log into the sports content personalization system 100 and access the personalized content 180-g, personalized based on the user data 138-i associated with their user profile 134-f.

FIG. 8 illustrates an embodiment of an exemplary computing architecture 800 suitable for implementing various embodiments as previously described. In one embodiment, the computing architecture 800 may comprise or be implemented as part of servers 110-a, servers 130-c, or clients 120-b.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, such as those described with reference to the processor circuit 140 shown in FIG. 1.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the client device 150. The servers 904 may implement summary engine device 110, and publication site 140. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

The various elements of the sports content personalization system 100 as previously described with reference to FIGS. 1-9 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method comprising:
receiving sports content at a server computing device, the sports content associated with content data related to subject matter of the sports content;
generating a user profile comprising user data, the user data indicating one or more sports content interests; and
presenting personalized sports content on a user interface comprising sports content selected based on the user data and the content data, the user interface presented on a display of a client computing device.

2. The computer-implemented method of claim 1, the content data comprising at least one of:
game information;
a sport;
a team;
a player;
a statistic; and
a content type.

3. The computer-implemented method of claim 1, the user data comprising at least one of:
demographic information;
previously accessed content information;
browsing patterns;
preferences;
a sport;
a team;
a player; and
a content type.

4. The computer-implemented method of claim 3, the preferences comprising at least one of:
a favorite sport;
a favorite team;
a favorite player; and
a favorite sports entity.

5. The computer-implemented method of claim 1, the user interface comprising a sports content provider website.

6. The computer-implemented method of claim 1, the sports content comprising at least one of:
video of a game event;
audio of a game event;
an article;
a contest; and
a discussion forum.

7. The computer-implemented method of claim 1, further comprising assigning weights to the user data according to sports content consumer interests.

8. An apparatus, comprising:
a transceiver;
a processor circuit coupled to the transceiver; and
a memory unit coupled to the processor circuit, the memory unit to store a sports content personalization application operative on the processor circuit to present personalized sports content on a user interface, the sports content personalization application comprising:
a sports content component operative to receive, via the transceiver, sports content associated with content data, the content data related to subject matter of the sports content;
a user profile component operative to generate a user profile comprising user data, the user data indicating one or more sports content interests;
a content personalization component operative to select personalized sports content based on the user data and the content data; and
a user interface component operative to present the personalized sports content on a user interface on a display of a client computing device.

9. The apparatus of claim 8, the content data comprising at least one of:
game information;
a sport;
a team;
a player;
a statistic; and
a content type.

10. The apparatus of claim 8, the user data comprising at least one of:
demographic information;
previously accessed content information;
browsing patterns;
preferences;
a sport;
a team;
a player; and
a content type.

11. The apparatus of claim 10, the preferences comprising at least one of:
a favorite sport;
a favorite team;
a favorite player; and
a favorite sports entity.

12. The apparatus of claim 8, the user interface comprising a sports content provider website.

13. The apparatus of claim 8, the sports content comprising at least one of:
video of a game event;
audio of a game event;
an article;
a contest; and
a discussion forum.

14. The apparatus of claim 8, the user profile component operative to assign weights to the user data according to sports content consumer interests.

15. At least one computer-readable storage medium comprising instructions that, when executed, cause a system to:
receive sports content associated with content data related to subject matter of the sports content;
generate a user profile comprising user data, the user data indicating one or more sports content interests; and
present personalized sports content on a user interface comprising sports content selected based on the user data and the content data, the user interface presented on a display of a client computing device.

16. The computer-readable storage medium of claim 15, the content data comprising at least one of:
game information;
a sport;
a team;
a player;
a statistic; and
a content type.

17. The computer-readable storage medium of claim 15, the user data comprising at least one of:
demographic information;
previously accessed content information;
browsing patterns;
preferences;
a sport;
a team;
a player; and
a content type.

18. The computer-readable storage medium of claim 17, the preferences comprising at least one of:
a favorite sport;
a favorite team;
a favorite player; and
a favorite sports entity.

19. The computer-readable storage medium of claim 15, the user interface comprising a sports content provider website.

20. The computer-readable storage medium of claim 15, the sports content comprising at least one of:
video of a game event;
audio of a game event;
an article;
a contest; and
a discussion forum.

21. The computer-readable storage medium of claim 15, comprising instructions that, when executed, cause the system to: assign weights to the user data according to sports content consumer interests.

22. A computer-implemented method comprising:
creating a user profile comprising user data with a sports content platform comprising sports content associated with content data, the content data related to subject matter of the sports content;
interacting with the sports content presented on a user interface to generate user data indicating one or more sports content interests; and
access personalized sports content on the user interface comprising sports content selected based on the user data and the content data.

23. The computer-implemented method of claim 22, the content data comprising at least one of:
game information;
a sport;
a team;
a player;
a statistic; and
a content type.

24. The computer-implemented method of claim 22, the user data comprising at least one of previously accessed content information and browsing patterns.
